(19) United States
(12) Patent Application Publication
(10) Pub. No.: US 2009/0008886 A1
(43) Pub. Date: Jan. 8, 2009

(54) Chuck

(76) Inventor: Zu-Shung Shu, Ta Li City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/772,426

(22) Filed: Jul. 2, 2007

(51) Int. Cl. B23B 5/22

(52) U.S. Cl. 279/103

(57) ABSTRACT

A chuck includes a body, a connector, a bit-retaining device and a pusher. The body includes a first section, a second section, a hexagonal hole defined in the first section and a circular hole defined in the second section. The connector includes a substantially circular and toothed section fit in the circular hole of the body. The bit-retaining device is movably mounted on the first section of the body between a releasing position where a bit can be inserted into and removed from the hexagonal hole of the body and a retaining position where the bit can be retained in the hexagonal hole of the body. The pusher is movably disposed in the body and used to push the bit from the hexagonal hole of the body in the releasing position of the bit-retaining device.

### BACKGROUND OF INVENTION

1. Field of the Invention

The present invention relates to a pneumatic or electrical rotating tool and, more particularly, to a chuck for use with a pneumatic or electrical rotating tool.

2. Related Prior Art

Referring to FIG. 1, a conventional chuck 1 includes a body 2, a connector 3 and a bit-retaining device 4. The bit-retaining device 4 is mounted on an end of the body 2 and used to retain a bit such as a screwdriver and a socket. The connector 3 is used to connect the body 2 to a pneumatic or electrical rotating tool. A circular hole is defined in another end of the body 2. The connector 3 includes a hexangular section fit in the circular hole of the body 2. When the hexangular section of the latter is fit in the circular hole of the former, the body 2 could however be deformed by the connector 3 so that the connector 3 would be connected to the body 2 in an eccentric or askew manner. Therefore, the rotation of the bit held by the chuck 1 would be un-smooth. Moreover, as the connector 3 is in contact with the body 2 in only six areas, the connection of the connector 3 to the body 2 is not firm. Therefore, a large torque cannot be transferred to the body 2 and, further, to the bit from the connector 3. The present invention is therefore intended to obviate or at least alleviate the problems encountered in prior art.

### SUMMARY OF INVENTION

According to the present invention, a chuck includes a body, a connector, a bit-retaining device and a pusher. The body includes a first section, a second section, a hexagonal hole defined in the first section and a circular hole defined in the second section. The connector includes a substantially circular and toothed section fit in the circular hole of the body. The bit-retaining device is movably mounted on the first section of the body between a releasing position where a bit can be inserted into and removed from the hexagonal hole of the body and a retaining position where the bit can be retained in the hexagonal hole of the body. The pusher is movably disposed in the body and used to push the bit from the hexagonal hole of the body in the releasing position of the bit-retaining device.

An advantage of the chuck according to the present invention is smooth operation of the bit held by the chuck.

An advantage of the chuck according to the present invention is a large torque that can be transferred to the body and, further, to the bit from the connector.

Other advantages, objectives and features of the present invention will become apparent from the following description referring to the attached drawings.

### BRIEF DESCRIPTION OF DRAWINGS

The present invention will be described via detailed illustration of the preferred embodiment in view of prior art referring to the drawings. FIG. 1 is a cross-sectional view of a conventional chuck.

FIG. 2 is a perspective view of a chuck according to the preferred embodiment of the present invention.

FIG. 3 is an exploded view of the chuck shown in FIG. 2.

FIG. 4 is a cross-sectional view of the chuck shown in FIG. 2.

FIG. 5 is a cross-sectional view of a bit held by the chuck shown in FIG. 2.

### DETAILED DESCRIPTION OF PREFERRED EMBODIMENT

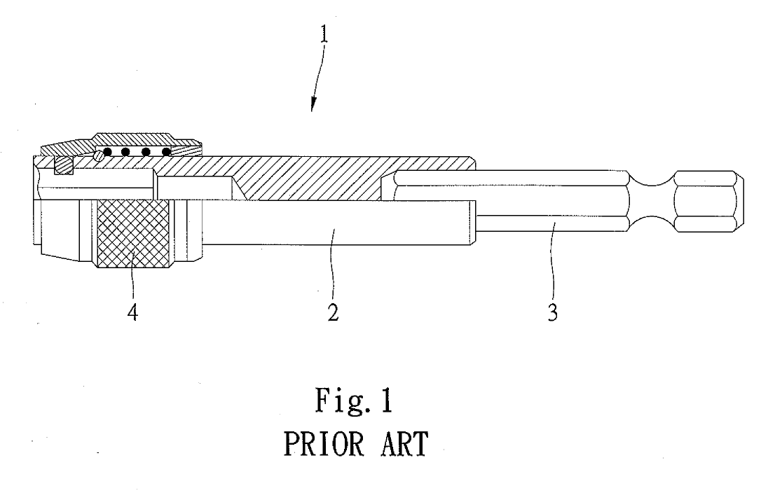

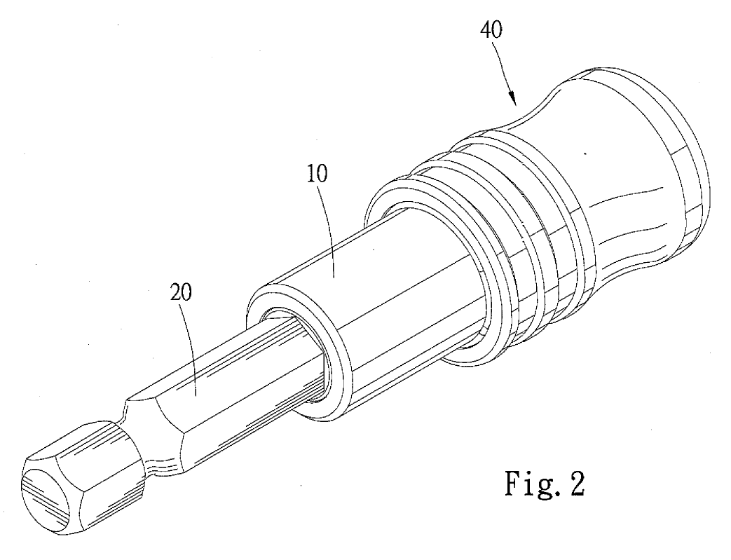

Referring to FIG. 2, according to the preferred embodiment of the present invention, a chuck includes a body 10, a connector 20 and a bit-retaining device 40.

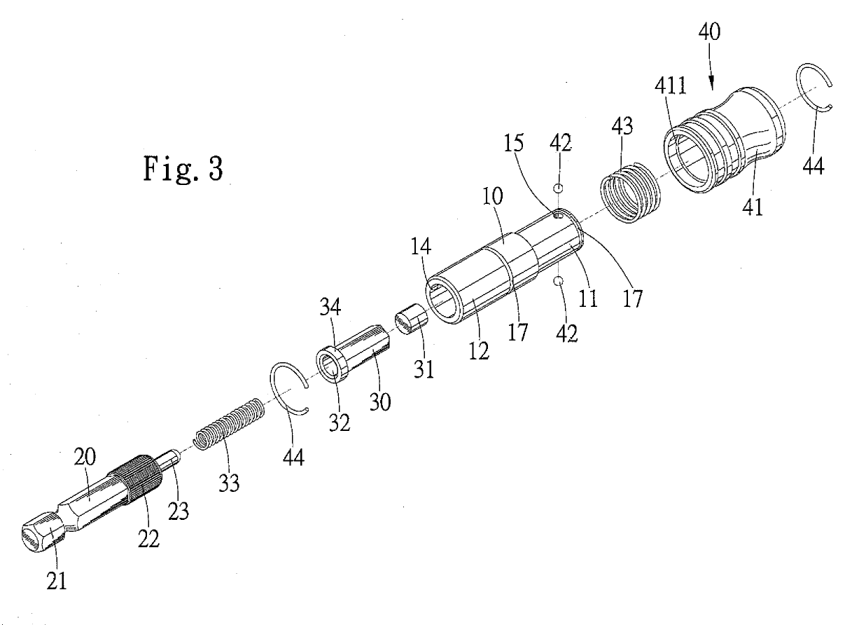

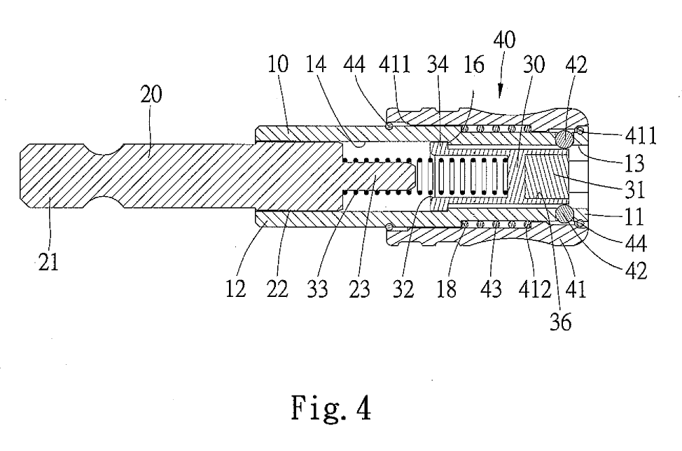

Referring to FIGS. 3 and 4, the body 10 is a tubular element and therefore includes an external side and an internal side. On the external side, the body 10 includes a first section 11, a second section 12 opposite to the first section 11, a shoulder 18 between the first section 11 and the second section 12, a groove 17 around the first section 11, another groove 17 around the second section 12. On the internal side, the body 10 includes a hexagonal hole 13, a circular hole 14 in communication with the hexagonal hole 13 and a shoulder 16 between the hexagonal hole 13 and the circular hole 14. The hexagonal hole 13 is substantially located in the first section 11. The circular hole 14 is substantially located in the second section 12. The body 10 includes two apertures 15 in communication with the hexagonal hole 13.

The bit-retaining device 40 includes two detents 42, an elastic element 43, two restraints 44 and a sleeve 41. The detents 42 are in the form of a ball and movably disposed in the apertures 15.

The elastic element 43 is a helical spring mounted on the first section 11 of the body 10.

The sleeve 41 includes two shoulders 411 on an internal side and opposite to each other and a ridge 412 on the internal side between the shoulders 411. The sleeve 41 is movably mounted on the body 10. The elastic element 43 is compressed between the ridge 412 of the sleeve 41 and the shoulder 18 of the body 10.

The restraints 44 are in the form of a C-clip and disposed in the grooves 17. The restraints 44 can be abutted against the shoulders 411 of the sleeve 41, thus retaining the sleeve 41 on the body 10.

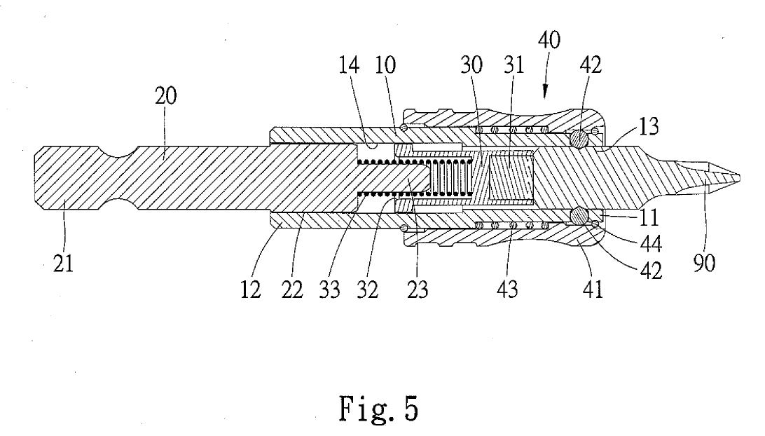

The sleeve 41 is normally located in a retaining position because of the elastic element 43. A user can move the sleeve 41 to a locking position where the detents 42 are moved from the hexagonal hole 13. Thus, a bit 90 (FIG. 5) can be inserted into or removed from the hexagonal hole 13.

Referring to FIG. 5, the sleeve 41 is released from the user, thus allowing the elastic element 43 to return the sleeve 41 to the locking position where the detents 42 are moved into the hexagonal hole 13 against the bit 90. Thus, the bit 90 is retained in the hexagonal hole 13.

A pusher 30 includes a first recess 36 defined therein, a second recess 32 defined therein opposite to the first recess 36 and a ridge 34 formed thereon. A magnet 31 is fit in the first recess 36 of the pusher 30 and used to magnetically attract the bit 90. The pusher 30 is disposed in the body 10. The pusher 30 includes a substantially hexagonal external side in compliance with the hexagonal hole 13 of the body 10. Thus, the pusher 30 is movable but not rotational in the body 10. The ridge 34 of the pusher 30 can be abutted against the shoulder 16 of the body 10 so that the pusher 30 cannot be removed from the body 10 through the hexagonal hole 13 of the body 10.

The connector 20 includes a first section 21, a second section 22 opposite to the first section 21 and a tip 23 extended from the second section 22. The first section 21 includes a hexagonal form can be connected to a pneumatic or electrical rotating tool. The second section 22 includes a substantially circular and toothed form. Thus, the second section 22 of the connector 20 can be smoothly inserted in the circular hole 14 of the body 10. Moreover; the second section 22 of the connector 20 is firmly disposed in the circular hole 14 of the body 10.

Before the connector 20, an elastic element 33 is disposed in the circular hole 14 of the body 10 and compressed between the pusher 30 and the connector 20. The elastic element 33 is a helical spring with an end disposed in the second recess 32 of the pusher 30 and another end mounted on the tip 23 of the connector 20. Biased by the elastic element 33, the pusher 30 pushes the bit 90 from the hexagonal hole 13 of the body 10 in the releasing position of the sleeve 41 so that the user can easily remove the bit 90 from the body 10. The magnet 31 is used to attract the bit 90 before the user reaches the bit 90.

The chuck according to the present invention exhibits at least two advantages. Firstly, the operation of the bit 90 held by the chuck is smooth since the connection of the connector 20 to the body 10 is co-axial. This is because the second section 22 of the connector 20 is substantially circular and is inserted in the circular hole 14 of the body 10 smoothly without deforming the body 10.

Secondly, a large torque can be transferred to the body 10 and, further, to the bit 90 from the connector 20 since the connection of the connector 20 to the body 10 is firm. This is because the second section 22 of the connector 20 is toothed and in contact with the wall of the circular hole 14 of the body 10 in many areas.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A chuck comprising:
a body comprising a first section, a second section, a hexagonal hole defined in the first section and a circular hole defined in the second section;
a connector comprising a substantially circular and toothed section fit in the circular hole of the body;
a bit-retaining device movably mounted on the first section of the between a body releasing position where a bit can be inserted into and removed from the hexagonal hole of the body and a retaining position where the bit can be retained in the hexagonal hole of the body; and
a pusher movably disposed in the body and used to push the bit from the hexagonal hole of the body in the releasing position of the bit-retaining device.

2. The chuck according to claim 1 wherein the body comprises at least one aperture in communication with the hexagonal hole, and the bit-retaining device comprises a sleeve movably mounted on the body, at least one detent movably disposed in the aperture of the body and an elastic element compressed between the sleeve and the body.

3. The chuck according to claim 2 wherein the body comprises two apertures, and the bit-retaining device comprises two detents movably disposed in the apertures of the body.

4. The chuck according to claim 2 comprising two restraints mounted on the body for restraining the sleeve.

5. The chuck according to claim 4 wherein the restraints are C-clips.

6. The chuck according to claim 5 wherein the body comprises two grooves for receiving the restraints.

7. The chuck according to claim 4 wherein the sleeve comprises two shoulders that is formed on an internal side thereof and can be abutted against the restraints.

8. The chuck according to claim 2 wherein the sleeve comprises a ridge formed on an internal side thereof, and the body comprises a shoulder formed on an external side thereof so that the elastic element is compressed between the ridge of the sleeve and the shoulder of the body.

9. The chuck according to claim 1 comprising an elastic element compressed between the connector and the pusher.

10. The chuck according to claim 9 wherein the pusher comprises a recess for receiving an end of the elastic element, and the connector comprises a tip inserted in an opposite end of the elastic element.

11. The chuck according to claim 1 comprising a magnet attached to the pusher and used to attract the bit.

12. The chuck according to claim 1 wherein the body comprises a shoulder formed on an internal side thereof, and the pusher comprises a ridge that is formed on an external side and can be abutted against the shoulder of the body.

13. The chuck according to claim 1 wherein the connector comprises a hexagonal section for connection to a rotating tool.
